(19) United States
(12) Patent Application Publication
(10) Pub. No.: US 2017/0300644 A1
(43) Pub. Date: Oct. 19, 2017

(54) SURVEILLANCE INFORMATION SYSTEM TO FACILITATE DETECTION AND REVIEW OF POTENTIAL HIPAA VIOLATIONS

(71) Applicant: The Regents of the University of California, Oakland, CA (US)

(72) Inventors: Monica Moldovan, Rocklin, CA (US); Carlos Aguilar, Elk Grove, CA (US); Joshua A. Simon, Sacramento, CA (US); John L. Nystrom, Sacramento, CA (US)

(73) Assignee: The Regents of the University of California, Oakland, CA (US)

(21) Appl. No.: 15/489,574

(22) Filed: Apr. 17, 2017

Related U.S. Application Data
(60) Provisional application No. 62/324,092, filed on Apr. 18, 2016.

(51) Int. Cl. G06F 19/00

(52) U.S. Cl. CPC G06F 19/328; G06F 19/322

(57) ABSTRACT

The disclosed embodiments relate to the design of a system that facilitates review of electronic healthcare records to identify potential Health Insurance Portability and Accountability Act (HIPAA) violations. During operation, the system obtains health-care-related data from electronic healthcare records for a population of patients from multiple data sources. The system then analyzes the obtained health-care-related data to generate cases-of-interest based on surveillance criteria associated with potential HIPAA violations, wherein each case-of-interest is related to a specific patient and a specific user who has accessed health-care-related data for the specific patient. Next, the system presents the cases-of-interest to an analyst through a user interface, and allows the analyst to indicate through the user interface whether each case-of-interest requires further investigation.

### CROSS-REFERENCE TO RELATED APPLICATION

This application claims priority under 35 U.S.C. §119(e) to U.S. Provisional Application Ser. No. 62/324,092, entitled “Surveillance Information System,” by inventors Monica Moldovan, et al., Attorney Docket Number UC15-634-1PSP, filed on 18 Apr. 2016, the contents of which are incorporated by reference herein.

### BACKGROUND

### Field

The disclosed embodiments generally relate to electronic health record (EHR) systems. More specifically, the disclosed embodiments relate to a surveillance information system, which analyzes data from an EHR system to facilitate detection and review of potential Health Insurance Portability and Accountability Act (HIPAA) violations.

### Related Art

As part of the HIPAA requirements for a medical center's privacy and security program, comprehensive privacy surveillance must be performed on all interactions between patients' charts and hospital/clinic staff to ensure that all accesses are appropriate and compliant with HIPAA standards. However, the sheer volume of audit logs and other data produced by large EHR systems creates a significant challenge in effectively performing these surveillance operations. Large medical centers often employ hundreds or thousands of staff members who provide medical care to tens of thousands of patients, and interactions between the staff members and patients generate tremendous volumes of data, which must be analyzed for HIPAA compliance.

Hence, what is needed is a surveillance system that can effectively monitor large EHR systems to detect HIPAA-related privacy violations.

### SUMMARY

The disclosed embodiments relate to the design of a system that facilitates review of electronic healthcare records to identify potential Health Insurance Portability and Accountability Act (HIPAA) violations. During operation, the system obtains healthcare-related data from electronic healthcare records for a population of patients from multiple data sources. The system then analyzes the obtained health-care-related data to generate cases-of-interest based on surveillance criteria associated with potential HIPAA violations, wherein each case-of-interest is related to a specific patient and a specific user who has accessed health-care-related data for the specific patient. Next, the system presents the cases-of-interest to an analyst through a user interface, and allows the analyst to indicate through the user interface whether each case-of-interest requires further investigation.

In some embodiments, obtaining and analyzing the health-care-related data involves using database tools to comb through a composite dataset obtained from multiple health-care-related computer systems to identify the cases-of-interest.

In some embodiments, the composite dataset is stored in a staging database, which is accessed while generating the cases-of-interest.

In some embodiments, prior to presenting the cases-of-interest to the analyst, the system uses one or more surveillance rules to exclude cases-of-interest associated with specific allowed types of access.

In some embodiments, prior to presenting the cases-of-interest to the analyst, the system enables an administrator to manually enter a case-of-interest through an administrative user interface.

In some embodiments, allowing the analyst to indicate whether a case-of-interest requires further investigation includes allowing the analyst to mark the case-of-interest as: a false-positive case; or a case that requires a compliance investigation.

In some embodiments, after the analyst has marked a case-of-interest as requiring a compliance investigation, the system: notifies a user associated with the case-of-interest about the potential HIPAA violation; and sends the case-of-interest to an investigative team to perform an investigation.

In some embodiments, the multiple data sources include: access logs including data associated with actions performed by users of systems that can access the electronic healthcare records; patient data for the population of patients; and user data for the users who can access the electronic healthcare records.

In some embodiments, the health-care-related data, which is obtained from the multiple data sources, includes: clinical information about the population of patients; administrative information about the population of patients; and administrative information about users who can access systems containing electronic healthcare records for the population of patients.

In some embodiments, each case-of-interest includes data that identifies: a patient; a user who accessed health-care-related data for the patient; a time period during which the access took place; and at least one surveillance criterion that triggered generation of the case.

### BRIEF DESCRIPTION OF THE FIGURES

FIG. 1 illustrates a surveillance information system in accordance with the disclosed embodiments.

FIG. 2 presents a flow chart illustrating operations performed by the surveillance information system in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Overview

The disclosed embodiments relate to a surveillance information system (SIS) for electronic health records, which is designed to analyze a massive data set by data-mining surveillance data from an electronic health record (EHR) system and associated ancillary systems. The system uses advanced application logic to filter the data down to manageable and comprehensible parts. The system includes selection logic that takes into consideration which types of user/patient interactions are most likely to constitute HIPAA violations. Each of the possible violations is compiled into a “case,” which is presented to an analyst for further review. As each case is presented′ to the analyst, the system can pull in secondary data relating to the case by accessing multiple source computer systems. The analyst can then make a determination to dismiss the case as a false positive, or can forward the case to a compliance office for review. The compliance office manages the cases and can make a determination regarding whether corrective actions are appropriate. Note that once cases are created and assigned, the process of reviewing and completing the case is done electronically within the SIS.

The SIS comprises an application that fully automates the privacy surveillance processes that are required as part of the HIPAA privacy and security policy. During operation, the application: consumes different data elements about patients and users; accesses their audit logs; and transforms them into a form suitable for consumption by business-intelligence processes that facilitate surveillance of users accessing patient records.

An important feature of the SIS is how privacy surveillance criteria filters are used to identify a type of user and a type of patient for a given access scenario. An exemplary privacy surveillance criteria comprises all patients that are employees who had an in-patient stay and had their EHR accessed by users who only work in outpatient clinics.

Hence, the SIS comprises software embodied in one or more applications that: (1) centralizes storage of access logs from clinical applications; (2) standardizes access log data obtained from the different systems; (3) creates a composite record and a single view of a user across different systems by incorporating all available user information and all different user identifiers that belong to the user; and (4) creates an enhanced patient record that allows the patient to be identified by different data attributes as is required to support various violation-detection techniques.

Moreover, the SIS provides the capability to: identify users and patients across multiple systems; create automated end-to-end privacy surveillance workflows, and use business rules to identify, search and create privacy cases to be reviewed and analyzed by front end users. The SIS can also consider user profiles and the user's relationships to patients to determine patient-to-user relationships that can lead to the inclusion or exclusion of specific privacy case scenarios.

This SIS is described in more detail below.

### Implementation Details

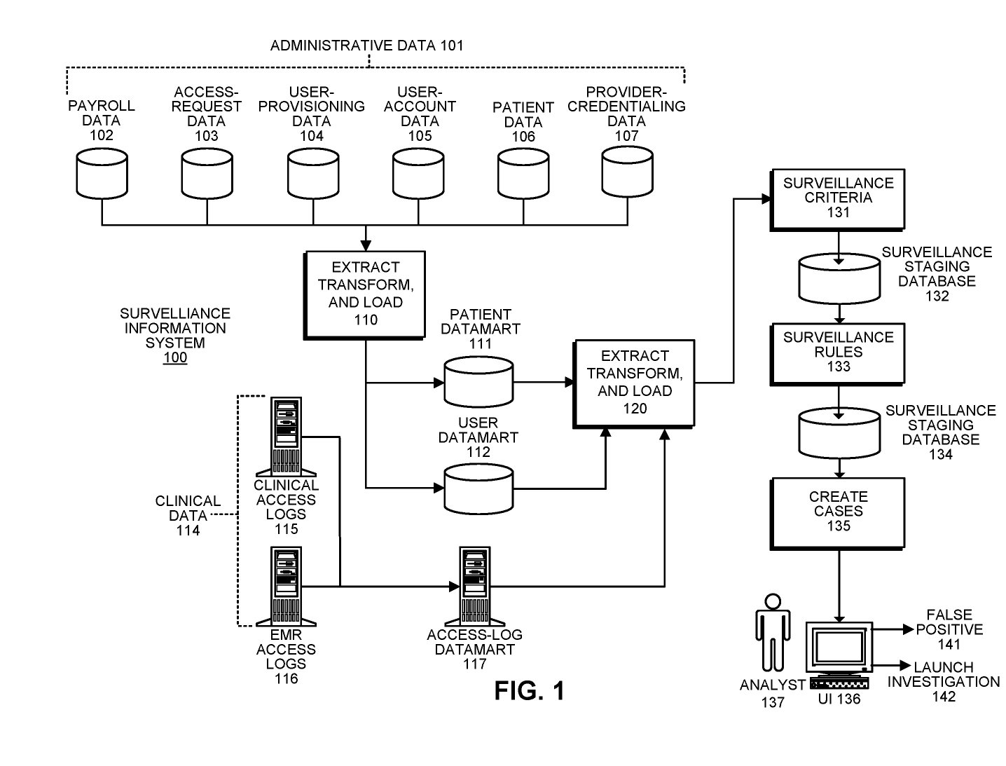

FIG. 1 illustrates an exemplary surveillance information system (SIS) 100 in accordance with the disclosed embodiments. As illustrated in FIG. 1, SIS 100 obtains administrative data 101 from various computer systems. This administrative data 101 includes: payroll data 102, access-request data 103, user-provisioning data 104, user-account data 105, patient data 106, and provider-credentialing data 107. This administrative data is extracted, transformed and loaded using module 110 into a patient datamart 111, which contains administrative data related to patients, and also a user datamart 112, which contains administrative data related to users. System 100 also obtains various clinical data 114, which for example includes clinical access logs 115 and EMR access logs 116. This clinical log data is stored in an access-log datamart 117.

System 100 then performs a number of operations on the extracted administrative data 101 and clinical data 114. Administrative and clinical data from patient datamart 111, user datamart 112 and access-log datamart 117 is extracted, transformed and loaded using module 120. Next, the output of module 120 is compared against various surveillance criteria 131 to create cases-of-interest, which are stored in surveillance staging database 132. Next, SIS 100 uses one or more surveillance rules 133 to exclude cases-of-interest associated with specific allowed types of access, and the remaining cases-of-interest are stored in surveillance staging database 134.

Next, module 135 creates the final collection of cases-of-interest and assigns them to various analysts for further review. As illustrated in FIG. 1, the system can present these cases-of-interest to an analyst 137 through a user interface (UI) 136, which enables the analyst to determine whether a specific case is a false positive 141, or to launch an investigation of the case 142. Note that when a case is being created, the system can use a unique composite key comprising a patient identifier, a user identifier, a surveillance criteria type, and a surveillance time period. Each case is then created and referenced through the SIS based on this composite key.

### Data Sources

SIS 100 obtains data from various data sources, including: access logs, patient data and user data to obtain sufficient data to enable the SIS to perform various operations including: (1) matching based on surveillance criteria; (2) managing the identity of users across all systems; and (3) making decisions about which access instances to include for review by surveillance analysts. As mentioned above, this data is stored in: access-log datamart 117, patient datamart 111 and user datamart 112.

Access-log datamart 117 includes log data from clinical systems. Because each clinical system may have different types of access logs, the system uses intermediary data jobs and tables to standardize the access logs within access-log datamart 117. During operation, access-log datamart 117 is used to: record a user's actions; provide a description of each action; store date stamps and timestamps for each action; and associate patients and users with actions performed by users.

Patient datamart 111 includes various patient data, which is used to support: case criteria, user-and-patient matching, clinic data, and demographics information. For example, the data in patient datamart 111 can include the following information: (1) a way to identify patients who are also employees; (2) for patients who are employees, human resource information, such as department, work address, supervisor, direct reports, etc.; (3) a patient's past and future encounters, including admission and discharge dates, encounter providers, primary care physician, care team, orders, procedures, labs, notes, etc.; and (4) a list of users who have provided care to the patient.

User datamart 112 includes demographic data associated with a user. This includes all work-related demographic information, such as: (1) a work address, (2) a work department that the user belongs to, (3) a job function, (4) a supervisor, (5) a department manager, and (6) information that identifies users who are patients, etc. A subset of this user data can include information about clinical users, including: specialty, practice details, provider types, provider medical staff membership, provider privileges, etc. Note that intermediary tables may be required to link user identifications across all clinical applications to a single user record.

### Staging of Data Based on Selected Criteria

In order to extract, transform and analyze data from all of the data sources, a staging database is used to perform various operations prior to a case being created for review by an analyst. The staging database is used as an area to separate records that are kept to facilitate case creation. Note that during this staging process, the system potentially manipulates millions of records to perform operations associated with analyzing surveillance criteria and associated filters. Various procedures and functions associated with the staging database as described in the list that appears below.
A function to generate a random date period, length of period, and parameters that are determined for each surveillance criteria as part of a business process. The random date period is then used as the date ranges that are sampled for surveillance purposes. For example, if the business process is to perform surveillance on 5 consecutive days, then the function would generate a 5-day period randomly within a given month.
A procedure to extract access logs from all clinical systems for the surveillance time period.
A procedure to extract related clinical data from all clinical systems for patients that are part of the access log data set for the surveillance time period.
A procedure to extract user data that belongs to all users that are part of the access log data set for the surveillance time period.
A procedure to filter and keep only records associated with specific criteria. For example, if the criteria specifies surveillance for users and patients that work in the same organization and in the same location as coworkers, then the procedure removes all patients that were not accessed by a coworker.
Procedures to remove any matches that fall under specific, clearly defined rules or workflows. These rules or workflows can be organization-specific, and can be applied or added to as needed. Exemplary rules include: (1) remove all potential cases where the user is the patient's primary care physician; (2) remove all potential cases where the user did not purposely seek to access the patient, but instead was prompted by the system to access the patient; (3) remove all potential cases which the user documented on the patient's chart; (4) remove all potential cases in which no clinical data was accessed about the patient; (5) remove all potential cases for which the patient was or will be seen in the user's clinical department. The remaining matches, along with related demographic data and related clinical data, are then used to create cases for review in the SIS.)
A procedure to load all clinical data using the referential keys into the SIS.
A procedure to load all demographic data using the referential keys into the SIS.
A procedure to load all access log data using the referential keys into the SIS.
A procedure to load a case row using the referential keys into the SIS.
A procedure to identify all available surveillance analysts and ensure that each analyst gets all cases related to the same patient, and to ensure all analysts receive the same number of patients and to randomly assign any remaining patients. (Hence, case assignments are processed as follow: each case is identified using a the unique combination of the patient ID, user ID, surveillance criteria type, and time period. All cases that are for the same patient, during the same surveillance time period and using the same surveillance criteria, are assigned to the same analyst. Finally, each analyst should receive the same number of patients and the number of cases will vary based on how many users accessed the patient. Any remaining patients are assigned randomly.)

### Case Management

After the cases are created, they are assigned to analysts in a privacy team. Each team member is randomly assigned a group of cases from each of the case-violation categories. For each assigned case, the analyst is presented with demographic information about the user and patient, related EHR encounters, and the actual access logs from the user's interaction with the patient.

The analyst uses the demographic information along with the encounter and log information to make a determination if a HIPAA violation has occurred. After making such a determination, the analyst has the option either to mark the case as a “false positive,” which will remove it from the work list, or to mark the case as due for a “compliance investigation,” which will move the case into a violation queue. Team members can also use peer-review functionality to send cases that require deeper analysis to other members of the privacy team to solicit their feedback.

Once a case has been identified as a violation, the analyst has the option to send a notification directly to the user, informing the user of the violation, or the analyst can forward the case on to a second tier for further review prior to informing the user. (This is useful in cases associated with potentially sensitive political situations.) Violations that are sent out are moved into a compliance-and-second-tier-review work list.

Once a user has been notified of a violation, the case is transferred to the investigation team's work list. From there, the investigation team can complete an investigation of the case and make notes on the case. Ultimately, the team can overrule the original decision and decide the case is a false positive, or they can take additional actions as necessary. All such actions are documented in the second tier review's case tracker.

It is sometimes necessary to manually enter a case that was not automatically captured by the system. The system allows for such manual entry of cases that were extracted from other systems. Once entered, these manually entered cases are used in the same way as any other cases.

### Operation of Surveillance Information System

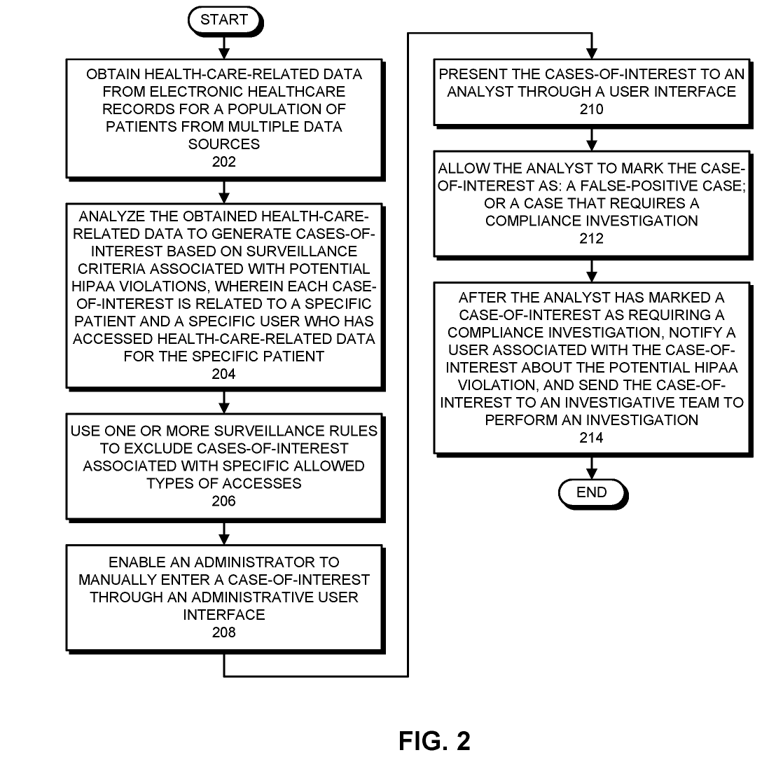

FIG. 2 presents a flow chart illustrating operations performed by the surveillance information system in accordance with the disclosed embodiments. First, the system obtains health-care-related data from electronic healthcare records for a population of patients from multiple data sources (step 202). Next, the system analyzes the obtained health-care-related data to generate cases-of-interest based on surveillance criteria associated with potential HIPAA violations, wherein each case-of-interest is related to a specific patient and a specific user who has accessed health-care-related data for the specific patient (step 204). The system also uses one or more surveillance rules to exclude cases-of-interest associated with specific allowed types of access (step 206). The system additionally enables an administrator to manually enter a case-of-interest through an administrative user interface (step 208). Next, the system presents the cases-of-interest to an analyst through a user interface (step 210). The system then allows the analyst to mark the case-of-interest as: a false-positive case; or a case that requires a compliance investigation (step 212). After the analyst has marked a case-of-interest as requiring a compliance investigation, the system: notifies a user associated with the case-of-interest about the potential HIPAA violation; and sends the case-of-interest to an investigative team to perform an investigation.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for facilitating review of electronic healthcare records to identify potential Health Insurance Portability and Accountability Act (HIPAA) violations, comprising:
obtaining health-care-related data from electronic healthcare records for a population of patients from multiple data sources;
analyzing the obtained health-care-related data to generate cases-of-interest based on surveillance criteria associated with potential HIPAA violations, wherein each case-of-interest is related to a specific patient and a specific user who has accessed health-care-related data for the specific patient;
presenting the cases-of-interest to an analyst through a user interface; and
allowing the analyst to indicate through the user interface whether each case-of-interest requires further investigation.

2. The method of claim 1, wherein obtaining and analyzing the health-care-related data involves using database tools to comb through a composite dataset obtained from multiple health-care-related computer systems to identify the cases-of-interest.

3. The method of claim 2, wherein the composite dataset is stored in a staging database, which is accessed while generating the cases-of-interest.

4. The method of claim 1, wherein prior to presenting the cases-of-interest to the analyst, the method further comprises using one or more surveillance rules to exclude cases-of-interest associated with specific allowed types of access.

5. The method of claim 1, wherein prior to presenting the cases-of-interest to the analyst, the method further comprises enabling an administrator to manually enter a case-of-interest through an administrative user interface.

6. The method of claim 1, wherein allowing the analyst to indicate whether a case-of-interest requires further investigation includes allowing the analyst to mark the case-of-interest as:
a false-positive case; or
a case that requires a compliance investigation.

7. The method of claim 1, wherein after the analyst has marked a case-of-interest as requiring a compliance investigation, the method further comprises:
notifying a user associated with the case-of-interest about the potential HIPAA violation; and
sending the case-of-interest to an investigative team to perform an investigation.

8. The method of claim 1, wherein the multiple data sources include one or more of the following:
access logs including data associated with actions performed by users of systems that can access the electronic healthcare records;
patient data for the population of patients; and
user data for the users who can access the electronic healthcare records.

9. The method of claim 1, wherein the health-care-related data, which is obtained from the multiple data sources, includes:
clinical information about the population of patients;
administrative information about the population of patients; and
administrative information about users who can access systems containing electronic healthcare records for the population of patients.

10. The method of claim 1, wherein each case-of-interest includes data that identifies:
a patient;
a user who accessed health-care-related data for the patient;
a time period during which the access took place; and
at least one surveillance criterion that triggered generation of the case.

11. A non-transitory computer-readable storage medium storing instructions that when executed by a computer cause the computer to perform a method for facilitating review of electronic healthcare records to identify potential Health Insurance Portability and Accountability Act (HIPAA) violations, the method comprising:
obtaining health-care-related data from electronic healthcare records for a population of patients from multiple data sources;
analyzing the obtained health-care-related data to generate cases-of-interest based on surveillance criteria associated with potential HIPAA violations, wherein each case-of-interest is related to a specific patient and a specific user who has accessed health-care-related data for the specific patient;
presenting the cases-of-interest to an analyst through a user interface; and
allowing the analyst to indicate through the user interface whether each case-of-interest requires further investigation.

12. The non-transitory computer-readable storage medium of claim 11, wherein obtaining and analyzing the health-care-related data involves using database tools to comb through a composite dataset obtained from multiple health-care-related computer systems to identify the cases-of-interest.

13. The non-transitory computer-readable storage medium of claim 12, wherein the composite dataset is stored in a staging database, which is accessed while generating the cases-of-interest.

14. The non-transitory computer-readable storage medium of claim 11, wherein prior to presenting the cases-of-interest to the analyst, the method further comprises using one or more surveillance rules to exclude cases-of-interest associated with specific allowed types of access.

15. The non-transitory computer-readable storage medium of claim 11, wherein prior to presenting the cases-of-interest to the analyst, the method further comprises enabling an administrator to manually enter a case-of-interest through an administrative user interface.

16. The non-transitory computer-readable storage medium of claim 11, wherein allowing the analyst to indicate whether a case-of-interest requires further investigation includes allowing the analyst to mark the case-of-interest as:
a false-positive case; or
a case that requires a compliance investigation.

17. The non-transitory computer-readable storage medium of claim 11, wherein after the analyst has marked a case-of-interest as requiring a compliance investigation, the method further comprises:
notifying a user associated with the case-of-interest about the potential HIPAA violation; and
sending the case-of-interest to an investigative team to perform an investigation.

18. The non-transitory computer-readable storage medium of claim 11, wherein the multiple data sources include one or more of the following:
access logs including data associated with actions performed by users of systems that can access the electronic healthcare records;
patient data for the population of patients; and
user data for the users who can access the electronic healthcare records.

19. The non-transitory computer-readable storage medium of claim 11, wherein the health-care-related data, which is obtained from the multiple data sources, includes:
clinical information about the population of patients;
administrative information about the population of patients; and
administrative information about users who can access systems containing electronic healthcare records for the population of patients.

20. The non-transitory computer-readable storage medium of claim 11, wherein each case-of-interest includes data that identifies:
a patient;
a user who accessed health-care-related data for the patient;
a time period during which the access took place; and
at least one surveillance criterion that triggered generation of the case.

21. A system, comprising:
at least one processor; and
a memory coupled to the at least one processor;
wherein the at least one processor executes program code stored on a non-transitory computer-readable storage medium, wherein the program code includes:
instructions for obtaining health-care-related data from electronic healthcare records for a population of patients from multiple data sources;
instructions for analyzing the obtained health-care-related data to generate cases-of-interest based on surveillance criteria associated with potential HIPAA violations, wherein each case-of-interest is related to a specific patient and a specific user who has accessed health-care-related data for the specific patient;
instructions for presenting the cases-of-interest to an analyst through a user interface; and
instructions for allowing the analyst to indicate through the user interface whether each case-of-interest requires further investigation.

22. The system of claim 21, wherein obtaining and analyzing the health-care-related data involves using database tools to comb through a composite dataset obtained from multiple health-care-related computer systems to identify the cases-of-interest.

23. The system of claim 22, wherein the composite dataset is stored in a staging database, which is accessed while generating the cases-of-interest.

24. The system of claim 21, wherein the program code includes additional instructions, which are executed prior to presenting the cases-of-interest to the analyst, wherein the additional instructions use one or more surveillance rules to exclude cases-of-interest associated with specific allowed types of access.

25. The system of claim 21, wherein the program code includes additional instructions, which are executed prior to presenting the cases-of-interest to the analyst, wherein the additional instructions enable an administrator to manually enter a case-of-interest through an administrative user interface prior to presenting the cases-of-interest to the analyst.

26. The system of claim 21, wherein allowing the analyst to indicate whether a case-of-interest requires further investigation includes allowing the analyst to mark the case-of-interest as:
a false-positive case; or
a case that requires a compliance investigation.

27. The system of claim 21, wherein the program code includes additional instructions, which are executed after the analyst has marked a case-of-interest as requiring a compliance investigation, wherein the additional instructions cause the system to:
notify a user associated with the case-of-interest about the potential HIPAA violation; and
send the case-of-interest to an investigative team to perform an investigation.

28. The system of claim 21, wherein the multiple data sources include one or more of the following:
access logs including data associated with actions performed by users of systems that can access the electronic healthcare records;
patient data for the population of patients; and
user data for the users who can access the electronic healthcare records.

29. The system of claim 21, wherein the health-care-related data, which is obtained from the multiple data sources, includes:
clinical information about the population of patients;
administrative information about the population of patients; and
administrative information about users who can access systems containing electronic healthcare records for the population of patients.

30. The system of claim 21, wherein each case-of-interest includes data that identifies:
a patient;
a user who accessed health-care-related data for the patient;
a time period during which the access took place; and
at least one surveillance criterion that triggered generation of the case.
